(19) United States
(12) Patent Application Publication
(10) Pub. No.: US 2014/0254010 A1
(43) Pub. Date: Sep. 11, 2014

(54) PROTECTIVE SHELL CAPABLE OF PROVIDING NAKED-EYE 3D IMAGING EFFECT

(71) Applicant: NATIONAL TAIWAN UNIVERSITY, Taipei (TW)

(72) Inventor: CHING-FUH LIN, Taipei (TW)

(73) Assignee: NATIONAL TAIWAN UNIVERSITY, Taipei (TW)

(21) Appl. No.: 13/788,572

(22) Filed: Mar. 7, 2013

(51) Int. Cl. G02B 27/22

(52) U.S. Cl. CPC G02B 27/225
USPC 359/477

(57) ABSTRACT

The present invention relates to a protective shell capable of providing naked-eye 3D imaging effect, and particularly relates to a protective shell of a handheld device capable of providing naked-eye 3D imaging effect to the handheld device. The protective shell includes a shell body and a 3D optical grating sheet. When the handheld device is put into the protective shell, the protective shell can provide a naked-eye 3D imaging effect for the handheld device by putting the 3D optical grating sheet on the display screen of the handheld device. Therefore, the user can see a 3D image on the display screen of the handheld device through the 3D optical grating sheet.

### BACKGROUND OF THE INVENTION

1. Field of the Invention

The present invention relates to a protective shell capable of providing a naked-eye 3D imaging effect, and particularly relates to a protective shell of a handheld device capable of providing a naked-eye 3D imaging effect to the handheld device.

2. Description of the Related Art

Now, 3D image technology is extensively applied in movies and TV for providing 3D visual effect. Generally, 3D image technology is classified into two different types: one is that a user can see a 3D image only through a special glasses such as polaroid glasses, shutter glasses; and another is that the movies and TV has a special optical element added therein for providing 3D visual effect such as a special optical film capable of transmitting a left-eye image only to the left eye of a user and transmitting a right-eye image only to the right eye of the user.

Recently, some companies try to apply the 3D image technology to a handheld device, which is often used in daily life or work, such as mobile phone, tablet PC, PDA, etc., for providing a 3D image on the handheld device. However, the 3D image technology, which has a need of the special glasses, is not suitable for the handheld device because it has a need of wearing the special glasses and this need is inconvenient for using and carrying the handheld device which is used frequently and convenient for carrying. For applying the 3D image technology, which has a need of addition of the special optical element, to the handheld device, the current design and manufacturing process of the handheld device need to be altered or modified to add the special optical element into the handheld device such as the special optical film. Therefore, not only the difficulty of manufacturing the handheld device is increased because of applying the 3D image technology having a need of addition of the special optical element but also the cost of manufacturing the handheld device is increased because of applying the 3D image technology having a need of addition of the special optical element.

Therefore, it has a need of a design capable of providing naked-eye 3D imaging effect to a handheld device without addition of a special optical element and altering of the current design and manufacturing process of the handheld device.

### SUMMARY OF THE INVENTION

In view of the foregoing, one object of the present invention is to provide a protective shell capable of providing naked-eye 3D imaging effect. This protective shell can provide a naked-eye 3D imaging effect to a handheld device without addition of a special optical element and altering of the current design and manufacturing process of the handheld device. Therefore, the manufacturing process of the handheld device capable of providing naked-eye 3D imaging effect can be simplified and the cost of the handheld device capable of providing naked-eye 3D imaging effect can be decreased.

According to one of the objects above, a protective shell capable of providing a naked-eye 3D imaging effect is disclosed herein. The protective shell comprises a shell body for holding or housing a handheld device having a display screen and a 3D optical grating sheet wherein one side of the 3D optical grating sheet is connected with one side of the shell body and the 3D optical grating sheet can be flipped from the front side of the shell body to the back side of the shell body. When the handheld device is put into the protective shell and the 3D optical grating sheet is put on the display screen of the handheld device, a 2D image shown in the display screen is converted into a left-eye image and a right-eye image by the image processing software, which is originally installed in the handheld device or is downloaded from a handheld device software downloaded platform (such as Android Play, iPhone App Store, Window Phone Marketplace, etc.). The left-eye image and the right-eye image are transmitted to the left eye and the right eye of a user respectively, and thereby the user can directly see a 3D image on the display screen of the handheld device with naked eyes. Therefore, the handheld device can provide a naked-eye 3D imaging effect by this protective shell without altering of the design and inner structure of the handheld device. Furthermore, the manufacturing process of the handheld device capable of providing naked-eye 3D imaging effect can be simplified and the cost of the handheld device capable of providing naked-eye 3D imaging effect can be decreased.

Therefore, the present invention provides a protective shell capable of providing a naked-eye 3D imaging effect. When this protective shell is used with a handheld device having a display screen, a naked-eye 3D imaging effect can be provided without using of a special glasses and addition of a special optical element into the handheld device. Therefore, the user can directly see a 3D image on the display screen of the handheld device with naked eyes. Furthermore, the manufacturing process of the handheld device capable of providing naked-eye 3D imaging effect can be simplified and the cost of the handheld device capable of providing naked-eye 3D imaging effect can be decreased.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a 3D drawing illustrating a protective shell capable of providing a naked-eye 3D imaging effect in accordance with an embodiment of the present invention.

FIG. 2A, FIG. 2B, and FIG. 2C are drawings in front view and back view of a combination of a handheld device and a protective shell capable of providing a naked-eye 3D imaging effect in accordance with an embodiment of the present invention respectively.

FIG. 3A and FIG. 3B are 3D drawings respectively illustrating a protective shell capable of providing a naked-eye 3D imaging effect, which has a fastening device, in accordance with different embodiments of the present invention,

FIG. 4A and FIG. 4B are locally enlarged drawings respectively illustrating a 3D optical grating sheet of a protective shell capable of providing a naked-eye 3D imaging effect in accordance with different embodiments of the present invention.

FIG. 5 is a 3D drawing illustrating a protective shell capable of providing a naked-eye 3D imaging effect in accordance with another embodiment of the present invention.

### DETAILED DESCRIPTION OF THE PREFERRED EMBODIMENT

The detailed description of the present invention will be discussed in the following embodiments, which are not intended to limit the scope of the present invention, and can be adapted for other applications. While drawings are illustrated in detail, it is appreciated that the quantity of the disclosed components may be greater or less than that disclosed, except where expressly restricting the amount of the components,

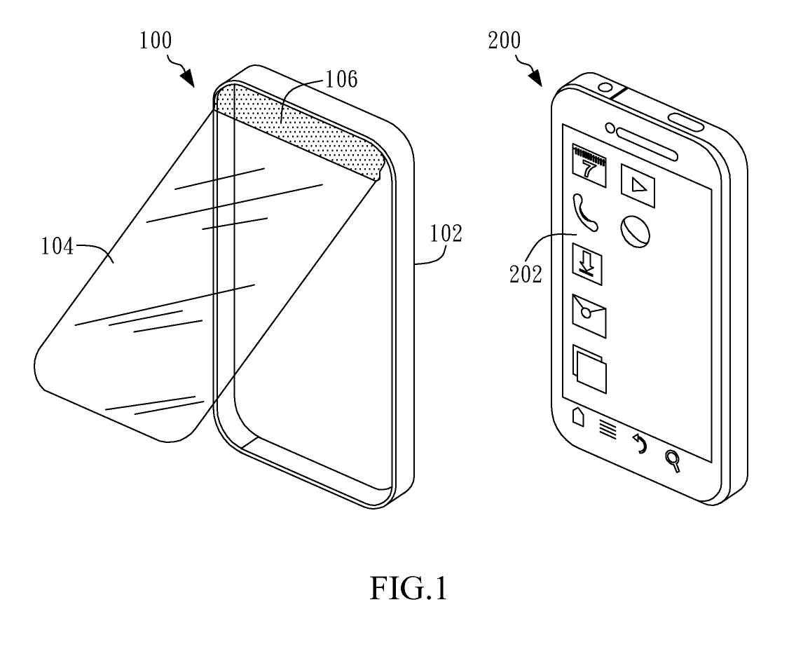

Referring to FIG. 1, It is a 3D drawing illustrating a protective shell 100 capable of providing a naked-eye 3D imaging effect in accordance with an embodiment of the present invention. The protective shell 100 comprises a shell body 102 and a 3D optical grating sheet 104 wherein one side of the 3D optical grating sheet 104 is connected with one side of the shell body 102 to form a clamshell design. It means that the 3D optical grating sheet 104 can be flipped from the front side of the protective shell 100 (or the shell body 102) to the back side of the protective shell 100 (or the shell body 102) freely. The shell body 102 is used to hold or house a handheld device 200 for providing a protection to the handheld device 200, but the shell body 102 does not obstruct the display screen 202. Therefore, the shell body 102 will not influence the user's view of the display screen 202 and the use of the handheld device 200. The shell body 102 is also used to fix the 3D optical grating sheet 104 on the handheld device 200 for providing a naked-eye 3D imaging effect, and particularly on the display screen 202 of the handheld device 200. There is a connecting part 106 on one side of the 3D optical grating sheet 104 and it is made of a flexible material. One side of the 3D optical grating sheet 104 is connected with one side of the shell body 102 by the connecting part 106. Therefore, the 3D optical grating sheet 104 can be flipped to the back side of shell body 102 when the 3D optical grating sheet 104 is not used. Of course in other embodiments of the present invention, the 3D optical grating sheet 104 may be made of a flexible material. Therefore, the 3D optical grating sheet 104 can be flipped between the front side and the back side of shell body 102 without the connecting part 106.

Generally, the handheld device 200 is a handheld device 200 having a display screen 202, for example mobile phone, tablet PC, PDA, touch screen phone, smart phone, touch screen tablet PC, etc. The handheld device 200 has an image processing software which can convert a 2D image shown in the display screen 202 into a left-eye image and a right-eye image. The image processing software is a software originally installed in the handheld device 200 or a software downloaded from a handheld device software downloaded platform, such as Android Play, iPhone App Store, Window Phone Marketplace, etc. By this image processing software, the handheld device 200 can convert the 2D image shown in the display screen 202 into the left-eye image and the right-eye image and show them in the display screen 202 to be seen by the user. The left-eye image and the right-eye image are respectively transmitted to the left eye and the right eye of the user, who is seeing the display screen 202, through the 3D optical grating sheet 104. Therefore, the left eye and the right eye of the user see images with different angles (the left-eye image and the right-eye image) respectively, and thereby a naked-eye 3D imaging effect can be made or provided.

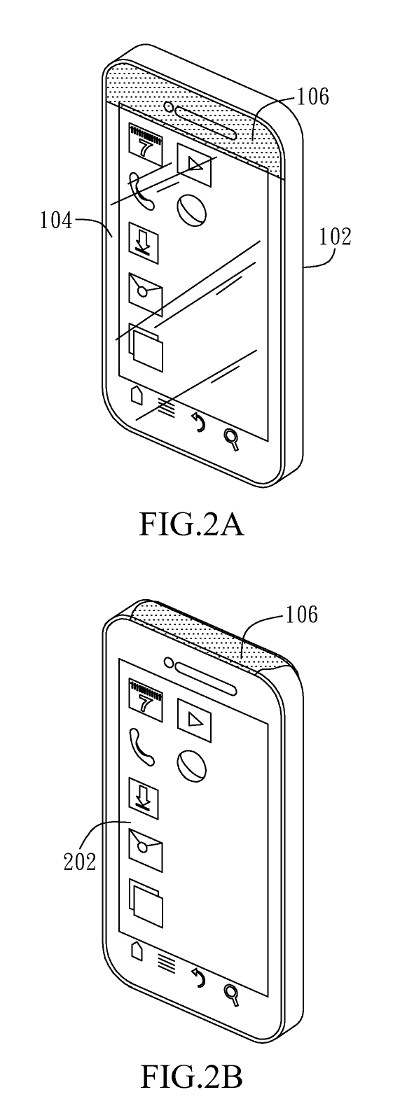

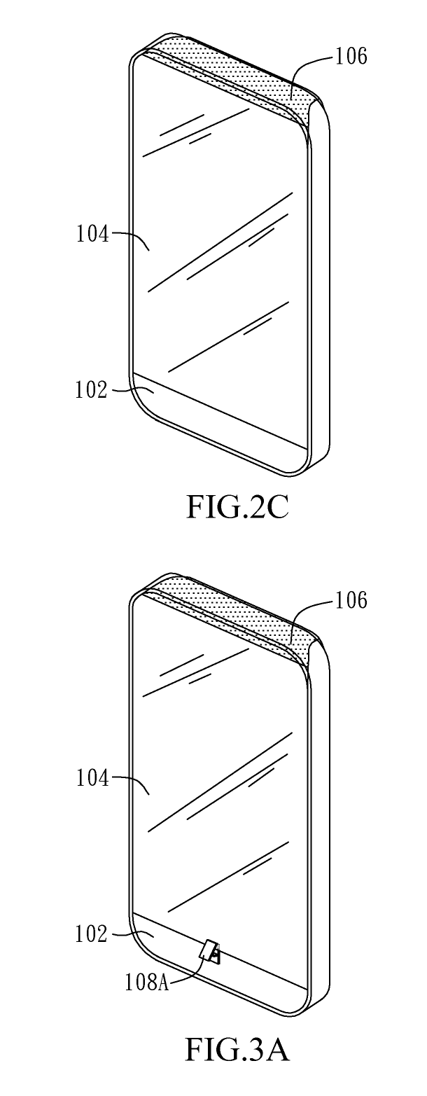

Referring to FIG. 2A, it is a drawing illustrating a combination of the handheld device 200 and the protective shell 100 capable of providing a naked-eye 3D imaging effect in accordance with an embodiment of the present invention. The shell body 102 of the protective shell 100 is a shell with a hollow front. The shell body 102 houses the handheld device 200 for putting or holding the handheld device 200 in the shell body 102, and the display screen 202 faces the front of the shell body 102 for exposing the display screen 202 from the shell body 102. The 3D optical grating sheet 104 is put on the display screen 202 of the handheld device 200. At this time, the handheld device 200 can detect whether the 3D optical grating sheet 104 is put on the display screen 202 by a sensor or detector of the handheld device 200, for example a touch sensor. Once the sensor or detector of the handheld device 200 detects that the 3D optical grating sheet 104 is put on the display screen 202 (as shown in FIG. 2A), the handheld device 200 will automatically access (or start) the image processing software to convert the 20 image shown in the display screen 202 into the left-eye image and the right-eye image and then they will be shown in the display screen 202. Or, after the 30 optical grating sheet 104 is put on the display screen 202 (as shown in FIG. 2A), the user can manually access (or start) the image processing software for converting the 20 image shown in the display screen 202 into the left-eye image and the right-eye image and showing the left-eye image and the right-eye image in the display screen 202.

When the user sees the left-eye image and the right-eye image in the display screen 202 of the handheld device 200 through the 3D optical grating sheet 104, the left eye of the user only can see the left-eye image in the display screen 202 and the right eye of the user only can see the right-eye image in the display screen 202. It is because the left-eye image is blocked from transmitting to the right eye of the user by the 3D optical grating sheet 104 and the right-eye image is blocked from transmitting to the left eye of the user by the 3D optical grating sheet 104. At this time, the left eye and the right eye of the user respectively see the left-eye image and the right-eye image of the same image (or object). It means that the left eye and the right eye of the user respectively see different images of the same image (or object) with different angles. The left-eye image and the right-eye image are automatically overlapped by the brain of the user to form a 3D image, and thus the user can see the 3D image with naked eyes.

Referring to FIG. 2B and HG. 2C, they are the drawings in front view and back view of a combination of the handheld device 200 and the protective shell 100 capable of providing a naked-eye 3D imaging effect with the 3D optical grating sheet 104 flipped to the back side of the handheld device 200. When the user does not need to see a 3D image, the 3D optical grating sheet 104 can be flipped to the back &de of the handheld device 200. At this time, the handheld device 200 detects that the 3D optical grating sheet 104 is no longer put on the display screen 202 (as shown in FIG. 2B) by the sensor or detector of the handheld device 200, for example a touch sensor, and then the handheld device 200 will automatically stop the image processing software in the handheld device 200 to stop converting the 2D image shown in the display screen 202 into the left-eye image and the right-eye image. Or, after the 3D optical grating sheet 104 is moved away from the display screen 202 (as shown in FIG. 2B) or the 3D optical grating sheet 104 is flipped from the display screen 202 to the back side of the handheld device 200 (as shown in FIG. 2C), the user can manually stop the image processing software in the handheld device 200 to stop converting the 2D image shown in the display screen 202 into the left-eye image and the right-eye image.

Therefore, by applying the protective shell 100 capable of providing a naked-eye 3D imaging effect with the image processing software in the handheld device which can convert the 2D image into the left-eye image and the right-eye image, the image shown in the display screen 202 of the handheld device 200 can be converted between the 2D image and the 3D image. It makes that the handheld device 200 can provide the 2D image or the 3D image in accordance with what choice the user makes. By this protective shell 100, the current handheld device, which originally has no 3D imaging effect (or function), can have a naked-eye 3D imaging effect for providing a 3D image in the situations that the user does not wear any special (3D) glasses and there is any additional special optical element added into the handheld device. Besides, the current handheld device, which originally has no 3D imaging effect (or function), can become a handheld device capable of providing a naked-eye 3D imaging effect by the protective shell of the present invention without altering of the original design and the original manufacturing process of the current handheld device because it has no need of wearing the special (3D) glasses and addition of additional special optical element into the current handheld device. Therefore, the manufacturing process of the handheld device capable of providing a naked-eye 3D imaging effect can be simplified and the cost of manufacturing the handheld device capable of providing a naked-eye 3D imaging effect can be decreased.

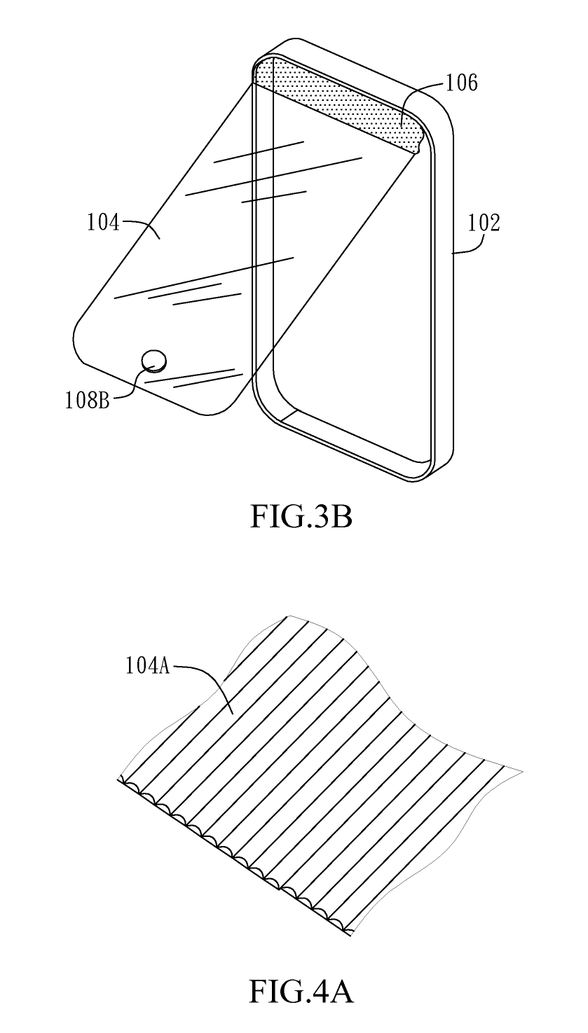

Additionally, referring to FIG. 3A, there is a fastening device 108A disposed on the back side of the protective shell 100, for example a dip, a magnet, a Velcro, or other similar devices. The fastening device 108A is used to fasten or fix the 3D optical grating sheet 104 on the back side of the handheld device 200 (or the shell body 102) while the 3D optical grating sheet 104 is flipped to the back side of the handheld device 200 (or the shell body 102). By this way, the 3D optical grating sheet 104 is fixed to prevent the 3D optical grating sheet 104 from damage and break caused by sway and impact of the 3D optical grating sheet 104 when the 3D optical grating sheet 104 is not used. Referring to FIG. 3B, it is a 3D drawing illustrating a protective shell capable of providing a naked-eye 3D imaging effect, which has a fastening device, in accordance with another embodiment of the present invention. In the protective shell 100 shown in FIG. 3B, the protective shell 100 also has a fastening device 108B. Similarly, the fastening device 108B is also used to fasten or fix the 3D optical grating sheet 104 on the back side of the handheld device 200 (or the shell body 102) while the 3D optical grating sheet 104 is flipped to the back side of the handheld device 200 (or the shell body 102). However, the difference between the fastening device 108A shown in FIG. 3A and the fastening device 108B shown in FIG. 3B is that the fastening device 108B is disposed on the 3D optical grating sheet 104 and particularly on the area of the 3D optical grating sheet 104 which does not shield the display screen 202. The fastening device 108A is a clip, a magnet, a Velcro, or other similar devices.

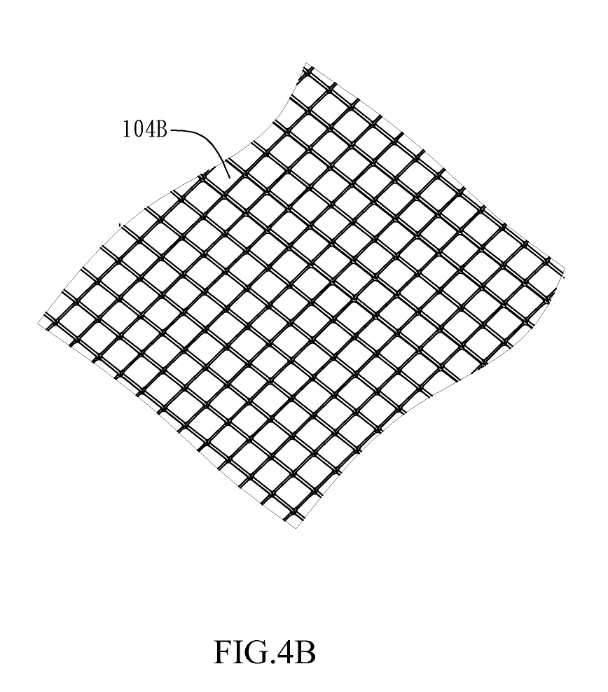

Furthermore, referring to FIG. 4A and FIG. 43, they are locally enlarged drawings respectively illustrating the 3D optical grating sheet of the protective shell capable of providing a naked-eye 3D imaging effect in accordance with different embodiments of the present invention. The 3D optical grating sheet of the protective shell of the present invention may be a 3D optical grating sheet 104A having a 1D structure (as shown in FIG. 4A). By this 1D structure, the left-eye image and the right-eye image shown in the display screen of the handheld device can be efficiently separated. Thus the left eye of the user only can see the left-eye image through the 3D optical grating sheet 104A and the right eye of the user only can see the right-eye image through the 3D optical grating sheet 104A. Therefore, in the embodiments of the protective shell of the present invention, the 3D optical grating sheet 104A needs to be put on the display screen of the handheld device while the user wants to see the 3D image, but the 3D optical grating sheet 104A needs to be moved away from the display screen of the handheld device (or flipped to the back side of the handheld device or shell body) to prevent the user from seeing an indistinct 2D image while the user wants to see the 2D image.

However, in other embodiment of the present invention, a 3D optical grating sheet 104B having a 2D structure (as shown in FIG. 4B) may be used as the 3D optical grating sheet of the protective shell of the present invention. In the 3D optical grating sheet 1043 having a 2D structure, the left-eye image and the right-eye image shown in the display screen of the handheld device can be efficiently separated by one dimension structure of the 2D structure, and the 2D image and the 3D image (includes the left-eye image and the right-eye image) can be efficiently separated by another dimension structure of the 2D structure. Therefore, in the embodiment of the 3D optical grating sheet 1043 of the present invention, the user can see the 2D image or the 3D image shown in the display screen of the handheld device directly through the 3D optical grating sheet 1043 without moving the 3D optical grating sheet 1043 away from the display screen (or flipping the 3D optical grating sheet 104B to the back side of the handheld device or the shell body). It means that the 3D optical grating sheet 1043 can be put on the display screen of the handheld device no matter viewing the 2D image or the 3D image and the user still can clearly see the 2D image and the 3D image shown in the display screen. Furthermore, both of cycles of the 3D optical grating sheets 104A and 104B are corresponded to pixels of the display screen of the handheld device.

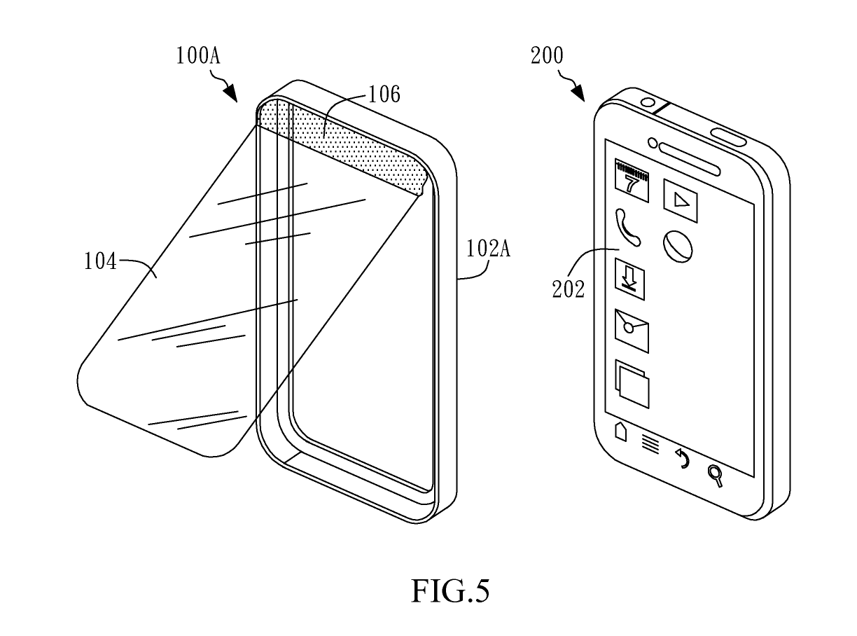

Furthermore, although the shell body 102 of the protective shell 100 shown in the foregoing embodiments is a shell with a hollow front (as shown in FIG. 1), in other embodiments of the present invention the shell body of the protective shell may be other types of shells on which the 3D optical grating sheet can be disposed. Referring to FIG. 5, it is a 3D drawing illustrating the protective shell 100A capable of providing a naked-eye 3D imaging effect in accordance with another embodiment of the present invention. The protective shell 100A shown in FIG. 5 and the protective she 100 shown in FIG. 1 have similar structure and similar elements. The difference between the protective shell 100A shown in FIG. 5 and the protective shell 100 shown in FIG. 1 is that the shell body 102A of the protective shell 100A is a shell with a hollow front and a hollow back. This shell body 102A houses or covers smaller area of the handheld device 200 and provides less protection to the handheld device 200 than the shell body 102. The major purpose of the shell body 102A is to dispose or fasten the 3D optical grating sheets 104 on the handheld device 200.

According to foregoing embodiments, a protective shell capable of providing a naked-eye 3D imaging effect is provided in this invention. When this protective shell is used with a handheld device having a display screen, a naked-eye 3D imaging effect can be provided without using of a special glasses and addition of a special optical element into the handheld device. Therefore, the user can directly see a 3D image on the display screen of the handheld device with naked eyes. Furthermore, the manufacturing process of the handheld device capable of providing naked-eye 3D imaging effect can be simplified and the cost of the handheld device capable of providing naked-eye 3D imaging effect can be decreased.

Although specific embodiments have been illustrated and described, it will be appreciated by those skilled in the art that various modifications may be made without departing from the scope of the present invention, which is intended to be limited solely by the appended claims.

What is claimed is:

1. A protective shell capable of providing naked-eye 3D imaging effect, comprising:
a shell body for holding or housing a handheld device having a display screen; and
a 3D optical grating sheet wherein one side of said 3D optical grating sheet is connected with one side of said shell body and said 3D optical grating sheet can be flipped from the front side of said shell body to the back side of said shell body.

2. The protective shell of claim 1, wherein said shell body is a shell with a hollow front.

3. The protective shell of claim 1, wherein said shell body is a shell with a hollow front and a hollow back.

4. The protective shell of claim 1, wherein said shell body comprises a fastening device for fixing said 3D optical grating sheet on the back side of said shell body while said 3D optical grating sheet is flipped to the back side of said shell body.

5. The protective shell of claim 4, wherein said fastening device is a clip, a magnet, or a velcro.

6. The protective shell of claim 1, wherein said 3D optical grating sheet comprises a fastening device for fixing said 3D optical grating sheet on the back side of said shell body while said 3D optical grating sheet is flipped to the back side of said shell body.

7. The protective shell of claim 6, wherein said fastening device is a clip, a magnet, or a velcro.

8. The protective shell of claim 1, wherein said handheld device comprises an image processing software capable of converting a 2D image into a left-eye image and a right-eye image.

9. The protective shell of claim 8, wherein said image processing software is an image processing software originally installed in said handheld device.

10. The protective shell of claim 8, wherein said image processing software is downloaded from a handheld device software downloaded platform to said handheld device.

11. The protective shell of claim 8, wherein when said 3D optical grating sheet is put on the front side of said handheld device or said display screen, said left-eye image is only transmitted to the left eye of a user though said 3D optical grating sheet and said right-eye image is only transmitted to the right eye of said user though said 3D optical grating sheet and thereby a naked-eye 3D imaging effect can be provided.

12. The protective shell of claim 11, wherein said user can manually choose whether said handheld device converts said 2D image into a left-eye image and a right-eye. image.

13. The protective shell of claim 11, wherein said handheld device further comprises a sensor for detecting whether said 3D optical grating sheet is put on the front side of said handheld device or said display screen.

14. The protective shell of claim 13, wherein when said sensor detects said 3D optical grating sheet on the front side of said handheld device or said display screen, said 2D image is automatically converted into a left-eye image and a right-eye image by said handheld device.

15. The protective shell of claim 1, wherein said 3D opt grating sheet is an optical grating sheet having a 1D structure.

16. The protective she of claim 1, wherein said 3D optical grating sheet is an optical grating sheet having a 20 structure.

17. The protective she of claim 16, wherein a user can see a 2D image and a 3D image through said 3D optical grating sheet by said 2D structure.

18. The protective shell of dam 1, wherein a cycle of said 3D optical grating sheet is corresponded to pixels of said display screen of said handheld device.
